(19) United States
(12) Patent Application Publication
(10) Pub. No.: US 2007/0182981 A1
(43) Pub. Date: Aug. 9, 2007

(54) Printing device

(76) Inventor: Seiji Aiso, Shiojiri-shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/645,145

(22) Filed: Dec. 21, 2006

(30) Foreign Application Priority Data
Dec. 26, 2005 (JP) 2005-371583

(51) Int. Cl. G06K 15/00

(52) U.S. Cl. 358/1.14; 358/1.15

(57) ABSTRACT

A printing device for printing images comprising: a display unit that displays images; an input unit that inputs a plurality of image data; a recommended image determination unit that for each of said input image data, calculates an evaluation value by evaluating specified items in relation to the level of deviation from the images shot under pre-specified conditions as the photographic images, and based on this evaluation value, determines whether or not each of said photographic images is a recommended image; a printing unit that selects images as a printing subject based on said judgment results and prints the selected images; an identifier storage unit that correlates an identifier to each of images selected as the printing subject and stores the identifier; and an image display unit that, after said image selected as the printing subject is printed, inquires for the stored identifier to judge the images not to be printed, and displays the judged images aligned in a specified sequence on said display unit. This printing device makes viewing and checking work easy when printing images, which improves the convenience for the user.

### CLAIM OF PRIORITY

The present application claims priority from Japanese application P2005-371583A filed on Dec. 26, 2005, the content of which is hereby incorporated by reference into this application.

### BACKGROUND

1. Field of the Invention

The present invention relates to printing of images on a printing device equipped with a display unit for displaying images.

2. Description of the Related Art

From the past, there have been printing devices that can print image data directly without going through a personal computer. These printing devices are equipped with a liquid crystal display that displays images, and the images input from a memory card or a digital still camera can be viewed using the liquid crystal display.

Many of the liquid crystal displays that this kind of printing device has are the small type, so it is difficult to judge the presence or absence of hand shake blur, blurred focus, or the like from the displayed image. In response to this problem, a method is being examined of evaluating the image subject to printing and executing printing based on that evaluation. For example, with Unexamined Patent No. 2002-187329, proposed is an image printing device that judges the presence or absence of hand shake blur or blurred focus of an image. With this device, disclosed is a technique for making it easy to select an image subject to printing according to the blurred focus. Also, in Unexamined Patent No. 2005-229355, disclosed is a constitution for which with a photograph automatic vending machine, several thumbnail photographs that are shot to be sold are arranged based on the evaluation value based on evaluation of the photograph, so that more selection is provided to the user.

However, regardless of the fact that it has become possible to judge image hand shake blur, blurred focus or the like; using this technique, it is difficult to perform up to the point of automatically setting the printing subject on the printing device side and performing printing. This is because when printing is performed automatically, a judgment cannot be reached of whether or not all the necessary images have been printed.

### SUMMARY

Considering the related arts, the problems that the present invention attempts to address are to make the work of viewing and confirming easier when printing images, and to improve user convenience.

To address the problems noted above, the printing device according to an aspect of the present invention comprises:

a display unit that displays images;

an input unit that inputs a plurality of image data,

a recommended image determination unit that for each of said input image data, calculates an evaluation value by evaluating specified items in relation to the level of deviation from the images shot under pre-specified conditions as the photographic images, and based on this evaluation value, determines whether or not each of said photographic images is a recommended image;

a printing unit that selects images as a printing subject based on said judgment results and prints the selected images;

an identifier storage unit that correlates an identifier to each of images selected as the printing subject and stores the identifier; and

an image display unit that, after said image selected as the printing subject is printed, inquires for the stored identifier to judge the images not to be printed, and displays the judged images aligned in a specified sequence on said display unit.

Also, the printing method according to an aspect of the present invention comprising:

inputting a plurality of image data;

for each of said input image data, calculating an evaluation value by evaluating specified items in relation to the level of deviation from the images shot under pre-specified conditions as the photographic images, and based on this evaluation value, determining whether or not each of said photographic images is a recommended image;

selecting images as a printing subject based on said determination results and printing the selected images;

correlating an identifier to each of images selected as the printing subject and storing the identifier; and

after said image selected as the printing subject is printed, inquiring for the stored identifier to judge the images not to be printed, and displaying the judged images aligned in a specified sequence on said display unit.

According to the aspect of the present invention, after specified images are printed by the printing device based on the determined recommended images, the images that were not printed are displayed. Therefore, among the images that were not printed, it is possible to easily perform the work of confirming whether or not there are images one desires to print, and it is possible to increase the convenience for the user.

### BRIEF DESCRIPTION OF THE DRAWINGS

FIG. 1 is an external view of the printing device as the image display device of the present invention;

FIG. 2 is an explanatory drawing showing the internal structure of the printing device;

FIG. 3A and FIG. 3B are explanatory drawings showing a summary of the printing process with the printing device;

FIG. 4 is a flow chart of the printing process;

FIG. 5 is a flow chart of the printing process;

FIG. 6 is an explanatory drawing showing an example of the display aspect of images that were not printed;

FIG. 7 is an explanatory drawing showing an example of the display aspect of images that were not printed;

FIG. 8A and FIG. 8B are explanatory drawings showing an example of the image display aspect;

FIG. 9 is an explanatory drawing showing an example of the image display aspect;

FIG. 10 is an explanatory drawing showing an example of the image display aspect; and

FIG. 11A and FIG. 11B are explanatory drawings showing a summary of the printing process including a step of confirming the images subject to printing.

### DESCRIPTION OF THE PREFERRED EMBODIMENTS

Following, to make the operation and effect of the present invention described above clearer, embodiments of the present invention are described in the following sequence.

A. Printing Device Constitution:

B. Printing Process Summary:

C. Printing Process:

D. Display Aspect:

E. Modifications:

A. Printing Device Constitution:

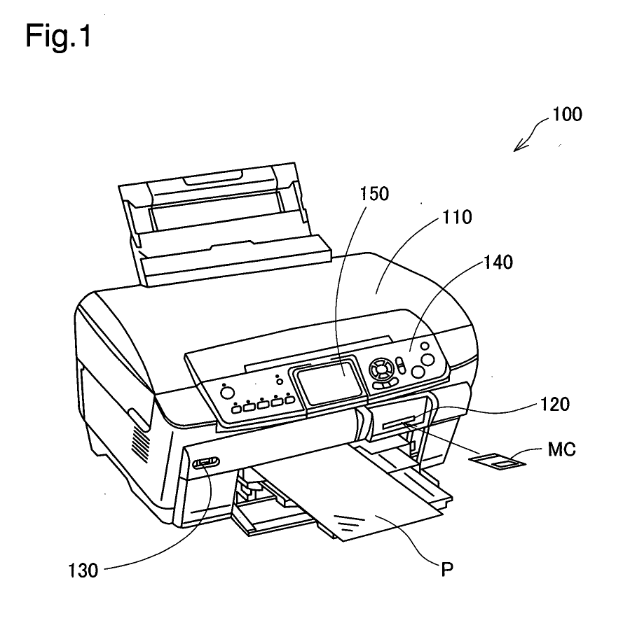

FIG. 1 is an external view of a printing device 100 as an embodiment of the present invention. The printing device 100 is a so-called complex type printing device, and is equipped with a scanner 110 that reads images optically, a memory card slot 120 for inserting a memory card MC on which image data is recorded, a USB interface 130 for connecting equipment such as a digital still camera, and the like. The printing device 100 can print on printing paper P images read by the scanner 110, images read from the memory card MC, and images read from a digital camera via the USB interface 130. Also, it can perform printing of images input from a personal computer (not illustrated) connected by a printer cable or the like.

The printing device 100 is equipped with an operating panel 140 for performing various operations related to printing. The center area of the operating panel 140 is equipped with a liquid crystal display 150. On this liquid crystal display 150, displayed are images read from the memory card MC, the digital still camera or the like, or a menu screen when using the various functions of the printing device 100.

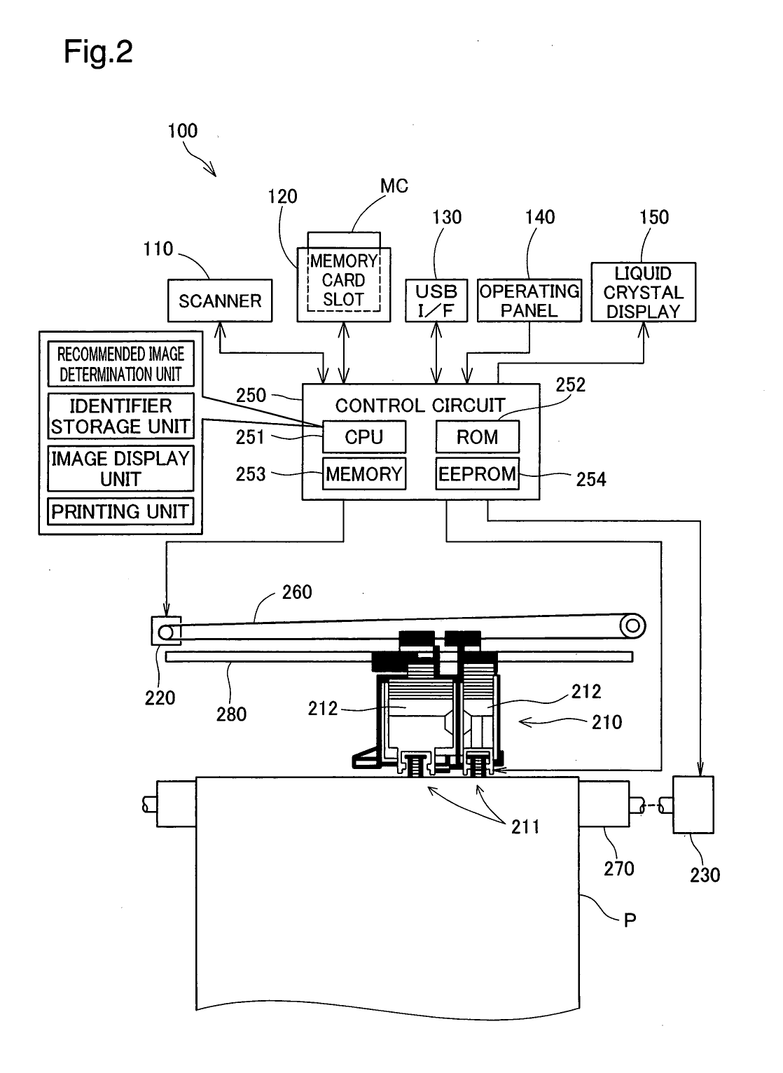

FIG. 2 is an explanatory drawing showing the internal structure of the printing device 100. As shown in the drawing, as the mechanism for performing printing on the printing paper P, the printing device 100 is equipped with a carriage 210 in which are incorporated ink cartridges 212, carriage motor 220 that drives the carriage 210 in the main scan direction, a paper feed motor 230 that conveys the printing paper P in the sub scan direction and the like.

The carriage 210 is equipped with a total of six ink heads 211 for each ink representing the colors cyan (C), magenta (M), yellow (Y), black (K), light cyan (Lc), and light magenta (Lm). Ink cartridges 212 housing these inks are mounted on the carriage 210, and the ink supplied from the ink cartridge 212 to the ink head 211 is sprayed on the printing paper P by driving of a piezo element (not illustrated).

The carriage 210 is held to be able to move freely on the sliding axis 280 arranged in parallel with the axial direction of a platen 270. The carriage motor 220 moves the carriage 210 back and forth parallel to the axial direction of the platen 270, specifically, in the main scan direction, by rotating a drive belt 260 according to instructions from a control circuit 250.

The paper feed motor 230 conveys the printing paper P perpendicular to the axial direction of the platen 270 by rotating the platen 270. Specifically, the paper feed motor 230 is able to move the carriage 210 relative to the sub scan direction.

The printing device 100 is equipped with the ink head 211 and the carriage motor 220 described above, and a control circuit 250 for controlling the operation of the paper feed motor 230. Connected to the control circuit 250 are the scanner 110, the memory card slot 120, the USB interface 130, the operating panel 140, and the liquid crystal display 150 shown in FIG. 1.

The control circuit 250 is constituted by a CPU 251, a ROM 252, a memory 253, and an EEPROM 254. Stored in the ROM 252 is a control program for doing comprehensive control of the operation of the printing device 100. The CPU 251, by expanding this control program in the memory 253 and executing it, performs display control on the liquid crystal display 150 and printing control of the images. Various parameters for which settings have been received from the user are stored in the EEPROM 254. The CPU 251 of this embodiment execute various processes under the OS (operating system) incorporated in advance in the ROM 252. This OS is capable of executing multiple tasks, and in addition to tasks executed in the foreground, can also execute other specified processes in the background. Stored in the ROM 252 of this embodiment is a printing process program for performing printing after setting the printing subjects automatically from the images within the memory card MC. Following, the processing contents of this process program are described.

B. Printing Process Summary:

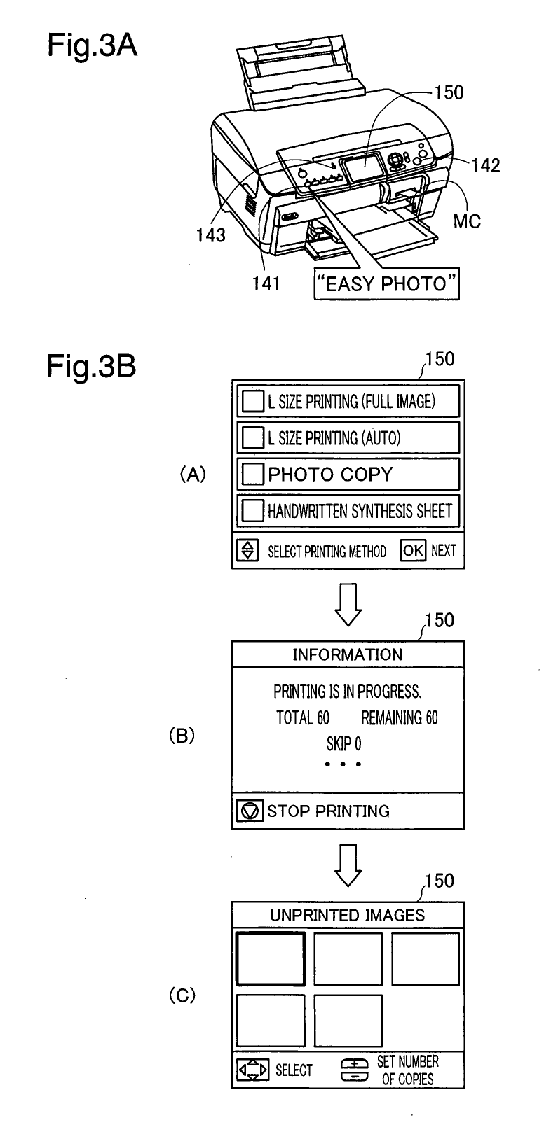

FIG. 3A and FIG. 3B are explanatory drawings showing a summary of the printing process at the printing device 100 of this embodiment. As shown in FIG. 3A, when the memory card MC is inserted in the memory card slot 120, and an “Easy Photo” button 141 which is one button on the operating panel 140 is pressed, as shown in FIG. 3B, a menu screen is displayed on the liquid crystal display 150.

As shown by the code (A) of FIG. 3B, four modes are represented on this screen, an “L size [3.5×5 inch] printing (full image)” mode for printing the full image within the memory card MC, an “L size printing (auto)” mode with the printing subject automatically set on the printing device 100 side from the images within the memory card MC and printing that image, a “Photo copy” mode for copying photographs using the scanner 110, and a “Handwritten synthesis sheet” mode for reading text or graphics written on a handwritten sheet using the scanner 110 and synthesizing with a specified image.

With this kind of menu screen, when the user operates a specified button on the operating panel 140 and selects the “L size printing (auto)” mode, sets it, and presses the start button 142, as shown by the code (B) of FIG. 3B, information is displayed on the liquid crystal display 150 indicating that printing is in progress.

During display of this information, the printing device 100 reads images from the memory card MC, and based on the specified evaluations, judges whether or not they are subjects for printing, and executes printing of images set as printing subjects. Note that as information, in addition to the point that printing is in progress, items such as the total number of images subject to processing, the remaining number of images, the number of images skipped without setting as printing subjects and the like are also displayed.

When printing of the images subject to printing ends on the printing device 100 side, on the liquid crystal display 150, as shown by the code (C) of FIG. 3B, a list of unprinted images is displayed.

Specifically, on the printing device 100 side, automatic judgment is made of whether or not to use as a printing subject, and printing is performed of images set as printing subjects, and after printing, the unprinted images are displayed. With this kind of image display, the user is able to easily confirm the unprinted images. For example, the user may find a desired image from the list of unprinted images on the liquid crystal display 150, and can also print that.

C. Printing Process:

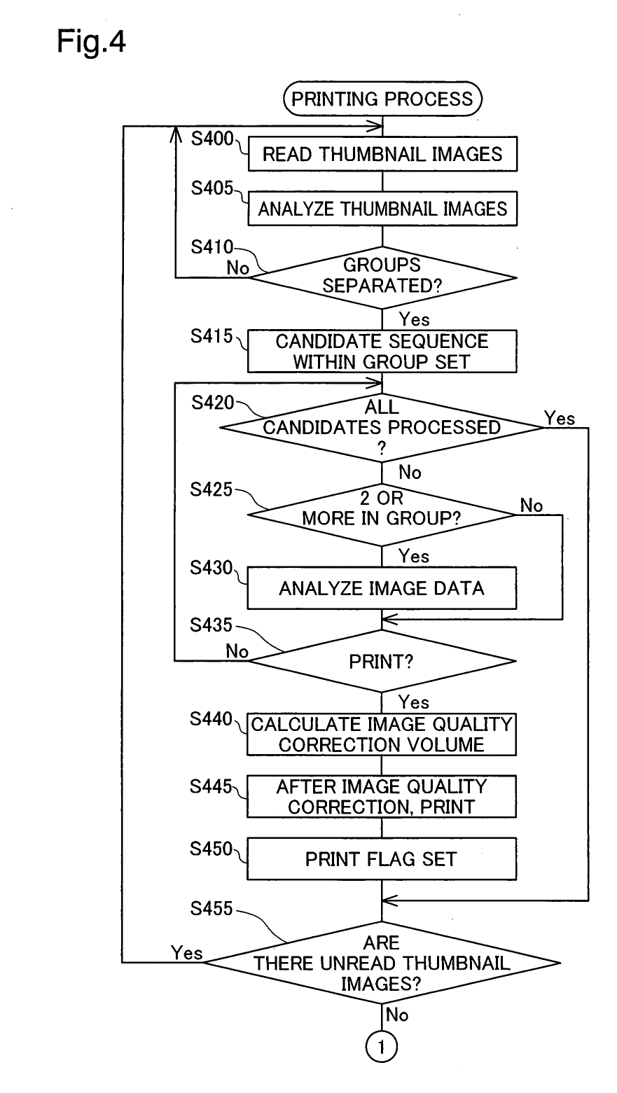

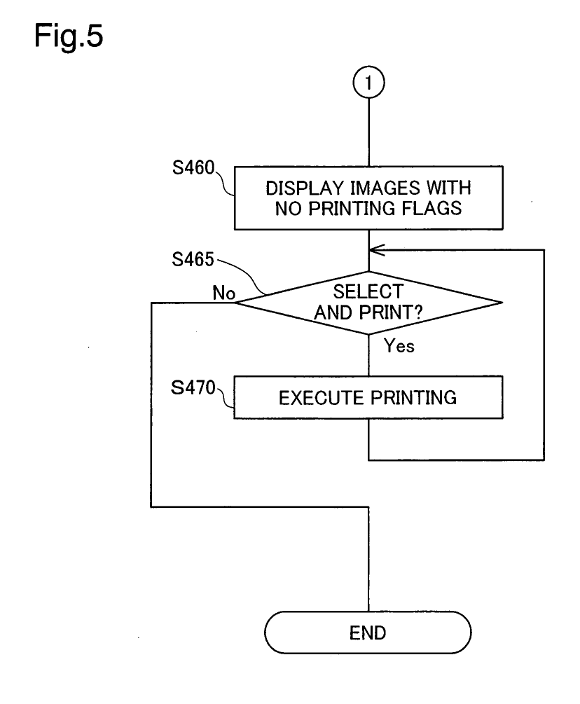

FIG. 4 and FIG. 5 are flow charts of the printing process realized by execution of the control program by the CPU 251. This process, as described above, is executed by inserting the memory card MC, and after selecting the “L size printing (auto)” mode, pressing the start button 142 on the operating panel 140.

When the process starts, the CPU 251 reads the thumbnail image of one image file in the memory card MC (step S400). The image files in the memory card MC handled with this embodiment are Exif format files. In addition to the image data itself, Exif format files are also equipped with additional recorded information such as the shot date and time, the shooting conditions, and the like. The thumbnail image is one of this additional information, and the CPU 251 reads this thumbnail image.

Subsequently, the CPU 251 analyzes the read thumbnail image (step S405). In specific terms, the brightness distribution is found for the thumbnail image, and based on this, an evaluation of the over or under exposure state as well as calculation for determination of similar images are performed.

The evaluation of the over or under exposure state is performed by, from the brightness distribution, extracting areas for which the brightness value of each image is a fixed value (e.g. 240) or greater, or a fixed value (e.g. 16) or less, and by setting an evaluation value according to the ratio that area occupies of the entire area of the image. For example, using a preset table for which if the area ratio is 25%, the evaluate value is 5, if the area ratio is 20%, the evaluation value is 4, and if the area ratio exceeds 25%, the evaluation value is 0, and the like, an evaluation is performed of the over or under exposure state of the thumbnail image. Here, images for which the evaluation value is a specified threshold value or less are judged to be insufficiently exposed, and ultimately these are not printed.

Calculation for determination of similar images is a calculation that obtains a specified numerical value by comparing the brightness values of adjacent images in time series. In specific terms, the difference of each rank value for the brightness distribution of both images is taken, these are added, and a numerical value (similarity level) is found. At a later step, the numerical value found here is used as determination data for determining whether or not the image being processed now is similar to the image processed immediately prior.

The CPU 251 which has analyzed the thumbnail images in this way determines the separation of similar image groups (step S410). In specific terms, when the specified numerical value calculated at step S405 is a preset threshold value or greater, it is judged that the image currently being processed is a non similar image to the immediately prior image, and when the specified numerical value is smaller than the preset threshold value, the image currently being processed is judged to be a similar image to the immediately prior image. Specifically, when judged to be non similar, it is judge that there is a separation of groups with the immediately prior image, and when judged to be similar, it is judged that there is no separation of groups with the immediately prior image.

At step S410, when it is judged that there is no group separation (No), the process returns to step S400, and the series of processes is repeated until there is a judgment that there is a group separation.

On the other hand, at step S410, when it is judged that there is a group separation (Yes), a ranking is given to the candidate images subject to printing belonging within the group (step S415). Ranking is performed based on the evaluation values set according to hand shake blur and blurred focus.

In specific terms, the CPU 251 reads the image data of the image file corresponding to the thumbnail image, does a first derivation of the brightness value of each image constituting the image data and extracts the edge, and based on the extracted edge, performs evaluation based on the image's level of hand shake blur or blurred focus.

The evaluation of the image hand shake blur is performed by calculating the edge direction and edge width in that direction by edge extraction, and by setting the evaluation value according to the volume of the edge width in that direction. For example, using a preset table for which if the edge width volume is 5 mm or less, the evaluation value is 20, if the edge width volume is around 30 mm, the evaluation value is 10, and if the edge width volume is around 50 mm, the evaluation value is 5, or the like, the hand shake blur evaluation is performed. Here, if the evaluation value is the specified threshold value or greater, it is judged to be an image with severe hand shake blur, and ultimately this is not printed.

Evaluation of blurred focus is performed by calculating the edge width in all directions by edge extraction, and by setting the evaluation value according to the edge width volume. In this case as well, the same as with the hand shake blur evaluation, a preset table is used.

In this way, a hand shake blur and blurred focus evaluation value is set for images in a group, and high ranking is given from images with a high evaluation value. Note that here, even with an image that does not have another similar image, this constitutes one group, and for items for which one image constitutes one group, that image rank is set as 1, and the hand shake blur and blurred focus evaluation is performed.

Subsequently, the CPU 251 determines whether or not processing has already been done for all the ranked candidate images within the group (step S420).

At step S420, when processing has already been done for all the candidate images (Yes), specifically, when it is judged that there are no unprocessed items for the images within the group, steps S425 to S450 thereafter are skipped, and the process moves to step S455.

On the other hand, at step S420, when processing has not been done for all the candidate images (No), specifically, when it is judged that there are unprocessed items for images within the group, a judgment is made of whether the number of images in the group is 2 or greater (step S425).

At step S425, when it is judged that the number of images within the group is 1, and is not 2 or more (No), the process moves to the printing determination process of step S435.

On the other hand, at step S425, when it is judged that the number of images within the group is 2 or more (Yes), an analysis of the image data subject to processing within the group is performed (step S430). The image data analysis performed at this step is an evaluation of preset specified items such as the image composition, the position of the face for people images, and the like.

For example, if it is a people image composition, image data is analyzed and facial recognition processing is performed, and when the position of the face is at the edge of the overall image, this is given a low point count, and when it is near the middle, it is given a high point count. The image evaluation is performed using this kind of point count.

When evaluation of specified items for one image within a group is performed in this way, or when the number of images within the group is 1, the CPU 251 judges whether or not to print that image (step S435).

With the process so far, for the images subject to processing, an evaluation value is set by an evaluation of the over or under exposure state or an evaluation of hand held blur or blurred focus. When this evaluation value is the specified threshold value or greater, this image has a high evaluation, and the CPU 251 performs a judgment to execute printing with this as a recommended image which is suitable as an image subject to printing. Conversely, when the evaluation value is lower than the specified threshold value, it performs a judgment not to execute printing with this as not suitable as an image subject to printing.

Note that when it is determined that there are a plurality of images in the group, for images for which evaluation of specific items (composition or the like) have been done, a comparison is also performed of the evaluation value of the composition or the like and a preset threshold value. Specifically, for images for which the evaluation value based on the over or under exposure state, hand held blur or the like is the specified value or greater, but the evaluation value of the image composition or the like is smaller than the specified threshold value, and the evaluation in terms of the image composition is low, a judgment is made of whether to hold that printing. In addition to evaluation of the exposure, hand held blur or the like, when the evaluation of the image composition and the like is also high, a judgment is made to execute printing.

At step S435, when it is judged to hold printing, or not to execute printing (No), the process returns to step S420, and a judgment is made of whether or not all the candidate images have already been processed. Specifically, a judgment is made of whether there is a next rank candidate image within the group. At step S420, when a next candidate image exists, a judgment is made of whether or not to print after performing evaluation of the image composition or the like for the other images as well. When an evaluation is performed of the composition or the like for the plurality of images in the group in this way, and none of them satisfy the specified criteria, for all the images in that group that were being held, the evaluation value of the exposure, hand held blur and the like and the evaluation value of the composition or combined to make a comprehensive judgment, and a judgment to print one image selected from within the group is made and the process advances to step S440.

On the other hand, when at step S435 a judgment to execute printing (Yes) is made, an image quality correction volume is calculated for that image (step S440), and after image quality correction is implemented, printing is executed (step S445). Image quality correction is known technology for correcting images within a memory card based on various conditions during shooting in order to faithfully print shot images, and for example, correction of contrast, brightness, sharpness, color saturation, memory color and the like is performed. The CPU 251 performs correction on the images subject to printing based on the image quality correction volume and prints image data after correction.

In specific terms, image data after correction is read, and by color conversion processing, RGB gradation value image data is converted to image data represented by each color gradation value of CMYKLcLm. After conversion, using halftone processing, the converted image data is converted to two gradation data of the presence or absence of dot formation, and a process of realigning considering the dot formation sequence is performed. Printing data of the image data is generated through this kind of processing, and various actuators such as a carriage motor 220, a paper feed motor 230 or the like are driven and printing is executed. Note that the number of printed sheets is set in advance as 1.

After the printing execution instruction, the CPU 251 sets a printing flag indicating that printing was executed for that image (step S450). In the memory 253 is equipped an area for storing printing flags (default value is “0”) corresponding to the image file, “1” is set for the printing flag corresponding to the image file for which printing execution was instructed, and this is stored. By viewing the printing flag for each image stored in the memory 253, it is possible to judge whether or not this is a printed image. Note that this flag can also have setting completed immediately before printing. In this case, for images for which printing failed, at the point that it is recognized that printing failed by various types of error messages or the like, it is also possible to have the flag setting reset.

Subsequently, the CPU 251 judges whether or not there are any unread items with the thumbnail images (step S455). At step S455, when it is judged that there are unread thumbnail images in the memory card MC (Yes), the process returns to step S400, the unread thumbnail images are read, and the series of processes is repeated. Note that the CPU 251 displays information on the liquid crystal display 150 while the series of processes is being repeated and the recommended images are being printed (see FIG. 3B).

On the other hand, when it is judged that there are no unread thumbnail images (No), specifically, when it is judged that all the images within the memory card MC have been processed, the printing flags within the memory 253 are confirmed, and images which do not have a printing flag (specifically, the printing flag is “0”) are displayed on the liquid crystal display 150 (step S460). Specifically, with this step, a list of unprinted images is displayed on the liquid crystal display 150. Note that the image display is performed after waiting for the end of the printing of all the recommended images.

After printing ends, the CPU 251 which has displayed a list of unprinted images judges whether or not there are images which require printing from among the displayed images (step S465). In specific terms, by the operation of a user who has confirmed the list of images, the specified image is selected, the printing count is specified, and a judgment is made of whether or not the printing instruction has been executed.

At step S465, when it is judged that there is an image to print (Yes), printing of the selected image is executed (step S470), the process returns to step S465, and a judgment is made of whether or not there are other images requiring printing.

On the other hand, at step S465, when it is judged that there are no images to be printed (No), display of the unprinted images is stopped, and the series of printing processes ends. Note that at this time, the printing flags stored in the memory 253 are cleared.

With the printing process noted above, after printing of the selected recommended images on the printing device 100 side, the unprinted images are displayed. Therefore, among the unprinted images, it is possible to easily perform the confirmation work of whether or not there are images one wishes to print. Then, when there are images one wishes to print, settings related to printing are performed on the display screen as is, and it is possible to execute printing. Therefore, it is possible to easily perform printing of the required images without waste, and it is possible to improve convenience for the user.

Also, when selecting the recommended images on the printing device 100 side, evaluation is performed for typical items as an evaluation of the photographic image including exposure, hand shake blur, and blurred focus. Therefore, it is possible to suitably select recommended images. Furthermore, similar images are made into a group, and from within the group, only 1 image is set as a recommended image. Therefore, there will not be printing of several similar images.

Note that the printing data generated at step S445 with this printing process is actually generated one movement part (one pass) at a time of the carriage 210 in the main scan direction. When one pass of printing data is generated, the CPU 251 drives the carriage motor 220, and while transporting the carriage 210 in the main scan direction, ink is sprayed from the ink head 211. After the end of one pass, the CPU 251 drives the paper feed motor 230, and is ready for the next one pass dot formation. During this time, the CPU 251 executes the process of driving a very low speed actuator (carriage motor 220, paper feed motor 230 or the like) seen from the CPU, so almost all of the time is in a process wait state. It is also possible to use this kind of wait state during printing to move to the next process. Specifically, the CPU 251 makes a priority of the process of printing execution allocated as the foreground, and while doing this, when there is a wait state, the evaluation process of images of the next group allocated as the background is executed. This kind of background processing can be realized with a multi task capable OS function. By working in this way, it is possible to rapidly perform the printing process, and it is possible to shorten the overall print processing time.

D. Display Aspect:

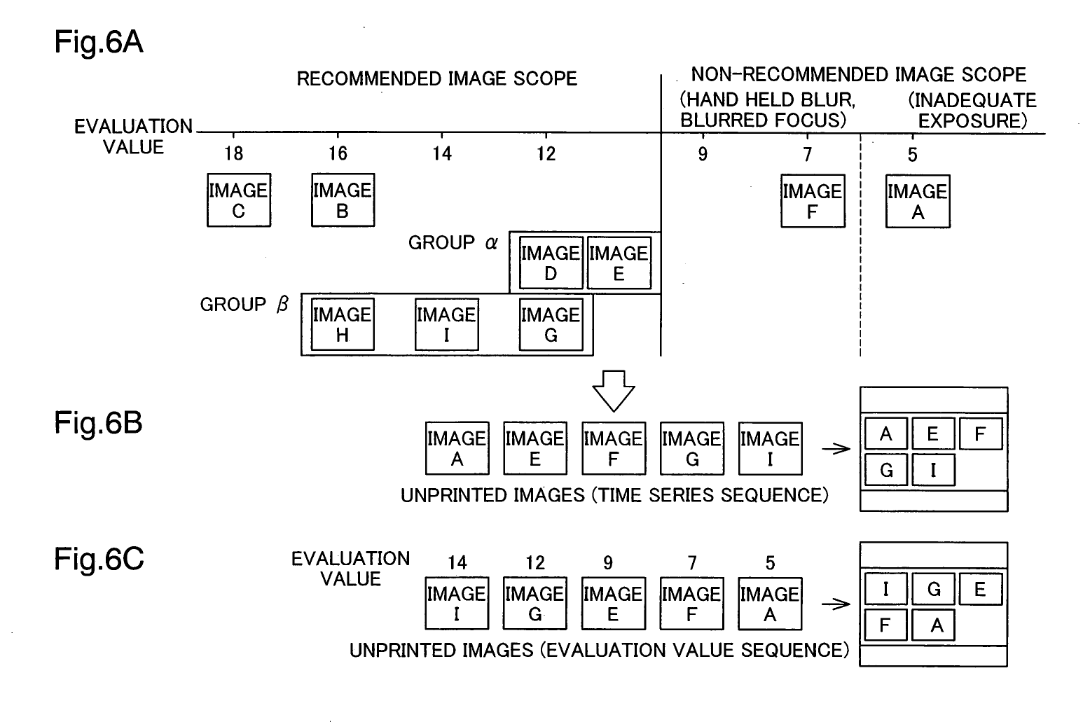

Next, described is the aspect of displaying unprinted images displayed with the printing process. FIG. 6 shows an example of the unprinted image display aspect. As shown by the code (A) in FIG. 6, from image A to image I are set as 9 images subject to the printing process in the time series sequence based on the shot date and time.

As a result of the printing process, evaluation values are set for the 9 images for items such as the exposure state, hand shake blur, blurred focus, and the like. Also, image D and image E are judged to be similar images and constitute group α, and image G, image H, and image I are judged to be similar images and constitute group β.

For group α, image D is ranked first and image E is ranked second, and the composition evaluation of the first image D fulfills the criteria, and image D is printed as is. Also, for group β, image H is ranked first, image I is ranked second, and image G is ranked third, the composition evaluation of the image H fulfills the criteria, and image H is printed as is. Furthermore, image B and image C have high evaluation values for the exposure state, hand shake blur, blurred focus and the like, and are printed.

Specifically, the unprinted images are the five images of image A and image F for which it is judged that the exposure is inadequate and the hand shake blur is severe, and the image E, image G, and image I for which it is judged that they satisfy the criteria for exposure, hand shake blur and the like, but in terms of the rest of the composition, there are similar images with high evaluations.

With this embodiment, a plurality of unprinted images are displayed together on one display screen (see code (C) in FIG. 3B). The sequence of the display is the time series sequence. Specifically, the five unprinted images shown by code (B) of FIG. 6 are aligned in time series sequence of image A, image E, image F, image G, and image I, and are displayed on the liquid crystal display 150. With this kind of display aspect, it is possible to make the user work of confirming images easy by displaying images in a logical manner.

Note that instead of the time series sequence, it is also possible to display in the sequence of the higher evaluation value for each image. In this case, the five unprinted images shown with code (C) of FIG. 6 are aligned in high evaluation value sequence of image I, image G, image E, image F, and image A, and are displayed on the liquid crystal display 150. By working in this way, it is possible to quickly confirm high evaluation items from among the unprinted images. In particular, when there are so many unprinted images that they cannot be displayed on one display screen, the images with the highest evaluation are displayed on the first display screen, so confirmation work is easy.

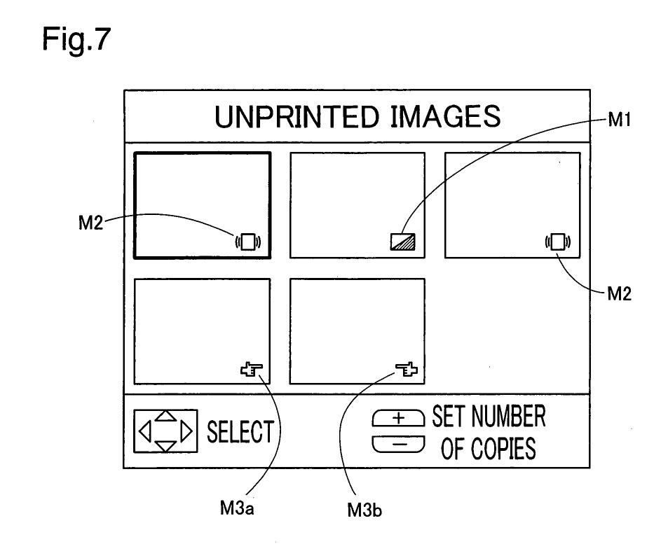

It is also possible to attach a reason for not printing and display this for the unprinted images displayed in this way. FIG. 7 is an example of the aspect of displaying the unprinted images. As shown in the drawing, the reason for not printing is encoded and displayed at the lower right of the unprinted image.

Code M1 means that this is an image for which the exposure state evaluation was low, code M2 means that this is an image for which the hand shake blur and blurred focus evaluation is low, and codes M3a and M3b mean that there are other similar images so these images were not printed.

The images in this display aspect are aligned in time series sequence, and the rightward direction indicated by the code M3a indicates that similar printed images exist afterwards in the time series. Similarly, the leftward direction indicated by the code M3b indicates that there are similar printed images before in the time series.

For unprinted images, the judgment of which code to display can be performed based on the evaluation value given to each image. For example, a very low evaluation value is given to the image with a low evaluation for the exposure state first judged with the printing process, and the difference with the evaluation value for the hand shake blur or the like is made clear. By working in this way, when an image has a very low evaluation value, that image is judged to have inadequate exposure and the code M1 is displayed, and in cases other than this, it is possible to judge these as images with hand shake blur and have the code M2 displayed. Also, for items grouped as similar images that were not printed, these can be displayed unambiguously with the code M3, and images printed within the group can be displayed with either code M3a or code M3b from the positional relationship in the time series.

By displaying together with the unprinted images the reason for not being subject to printing, it is possible to easily understand the image contents. This is particularly effective when displaying a plurality of unprinted images on a small liquid crystal display. Note that the reasons for not being subject to printing can also be displayed using a different code, text or the like. Alternatively, it is also possible to give notice of the reason for not printing using a voice each time the user points to an image.

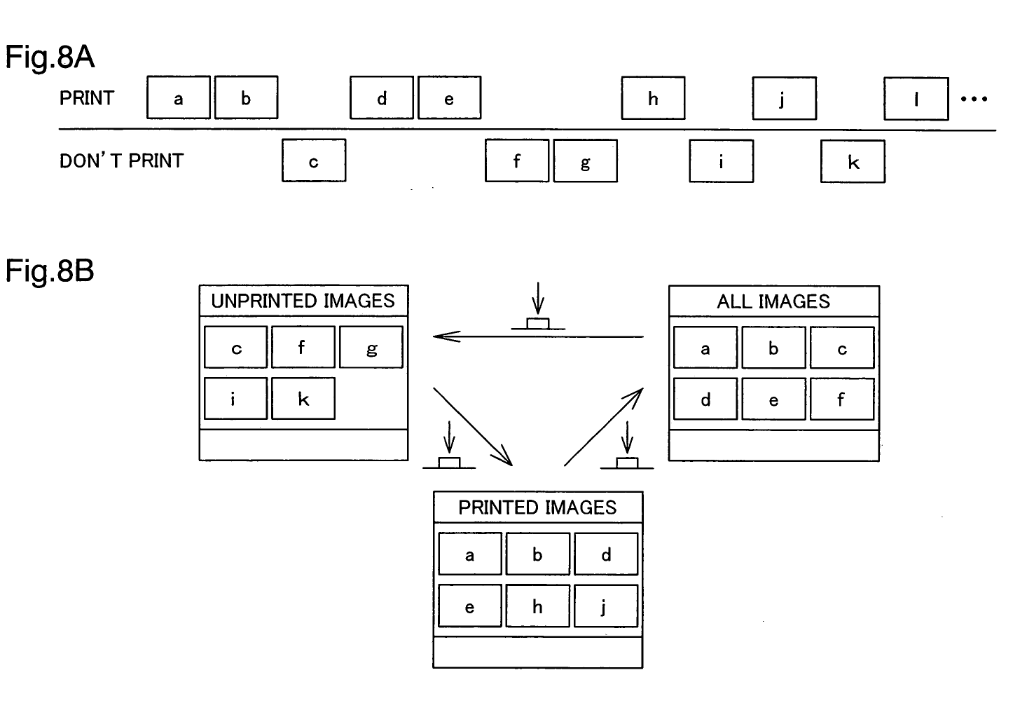

With the description above, a situation with only unprinted images being displayed was described, but by referencing the printing flag set by the printing process, it is also possible to display printed images. FIG. 8 is an example of the aspect of displaying images. As shown in the drawing, the printing process is performed for images from image a to image 1, and the five unprinted images are displayed on the liquid crystal display 150.

Here, when the user presses the display switch button 143 (see FIG. 3A) on the operating panel 140 once, the display screen on the liquid crystal display 150 switches, and the printed images are displayed.

Here, when the display switch button 143 is pressed once again, the display screen on the liquid crystal display 150 switches, and regardless of whether there was printing or not, all the images subject to printing are displayed. After that, when the display switch button 143 is pressed once yet again, this returns to the original display of unprinted images.

By switching the display screen according to the number of presses of the operating button in this way, it is possible to easily confirm various images.

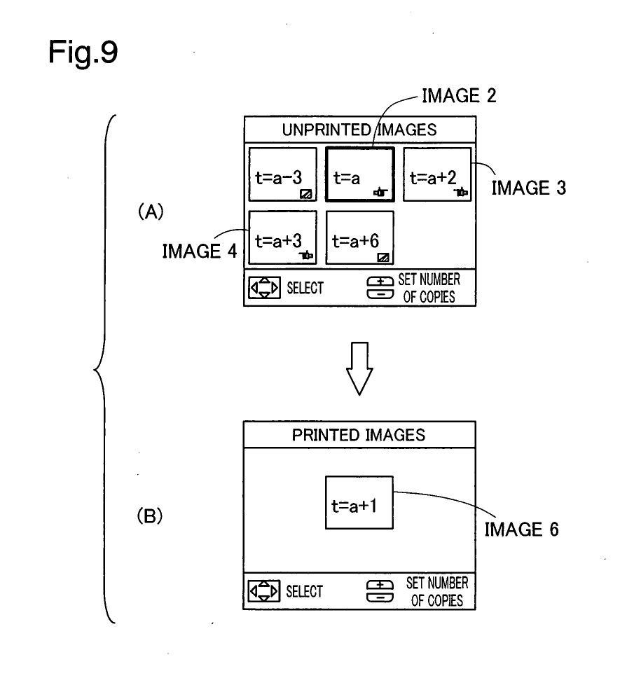

Also, switching of the displayed images can also be performed between displaying a plurality of images or displaying a single image. This state is shown in FIG. 9. FIG. 9 shows an example of the aspect of displaying images. As shown by the code (A) in FIG. 9, the five unprinted images are displayed together with that reason from the start. The time t in the drawing represents the date and time the image was shot, and the five images are displayed in time series sequence.

With this kind of display screen, when image 2 (t=a), which was not printed because there were similar images, is selected, and the display switch button 143 is pressed, the system switches to display of image 6 (t=a+1) printed corresponding to that image (see code (B) of FIG. 9). Specifically, it is possible to switch to the display screen of printed image 6 in the group to which image 2 belongs. By working in this way, it is possible to easily confirm items printed with similar images based on unprinted images. Note that with the display aspect of FIG. 9, whichever of unprinted image 2, image 3, or image 4 belonging to the same group is selected, it is possible to confirm image 6.

Instead of this kind of display aspect limited to similar images, it is also possible to use an aspect of displaying printed images at positions near in time to selected images regardless of which image is selected from the unprinted image display screen.

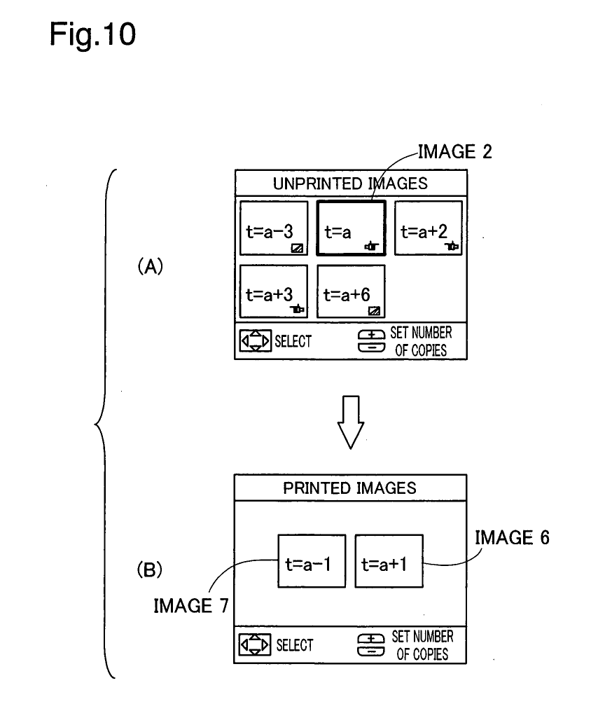

FIG. 10 shows an example of the image display aspect. As shown in the drawing, the same as with FIG. 9, on the display screen (code (A) of FIG. 10) for which the five unprinted images and that reason are displayed together, when the unprinted image 2 (t=a) is selected and the display switching button 143 is pressed, of the printed images, this switches to display of image 6 (t=a+1) and image 7 (t=a−1) which are near in time with image 2 at the center. By using this kind of display aspect, confirmation of unprinted images or printed images is easy.

E. Modifications:

Above, various embodiments of the present invention were described, but the present invention is not limited to these kinds of embodiments, and it is obvious that it is possible to use various constitutions in a scope that does not stray from the key points. For example, functions realized using software can be realized using hardware. In addition, the following variations are possible.

With the printing process of this embodiment, an evaluation of the images in the memory card MC was performed at the printing device 100 side, and the printing subjects were set automatically and printed, but it is also possible to have a printing process equipped with a step for which the user is able to confirm images set automatically as printing subjects on the printing device 100 side.

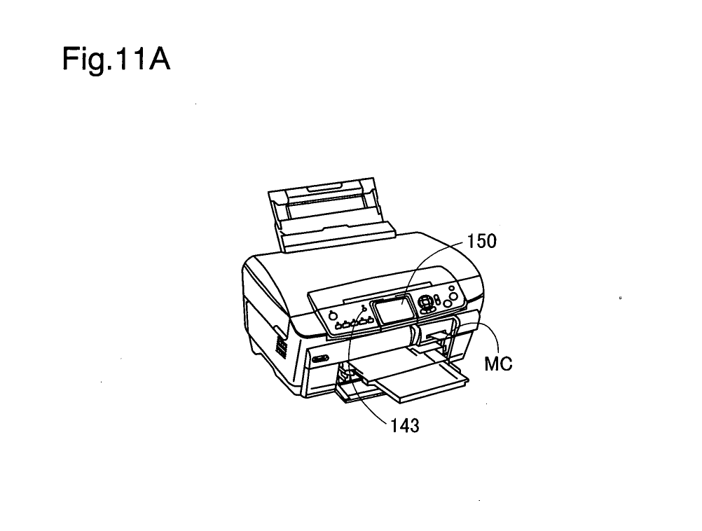

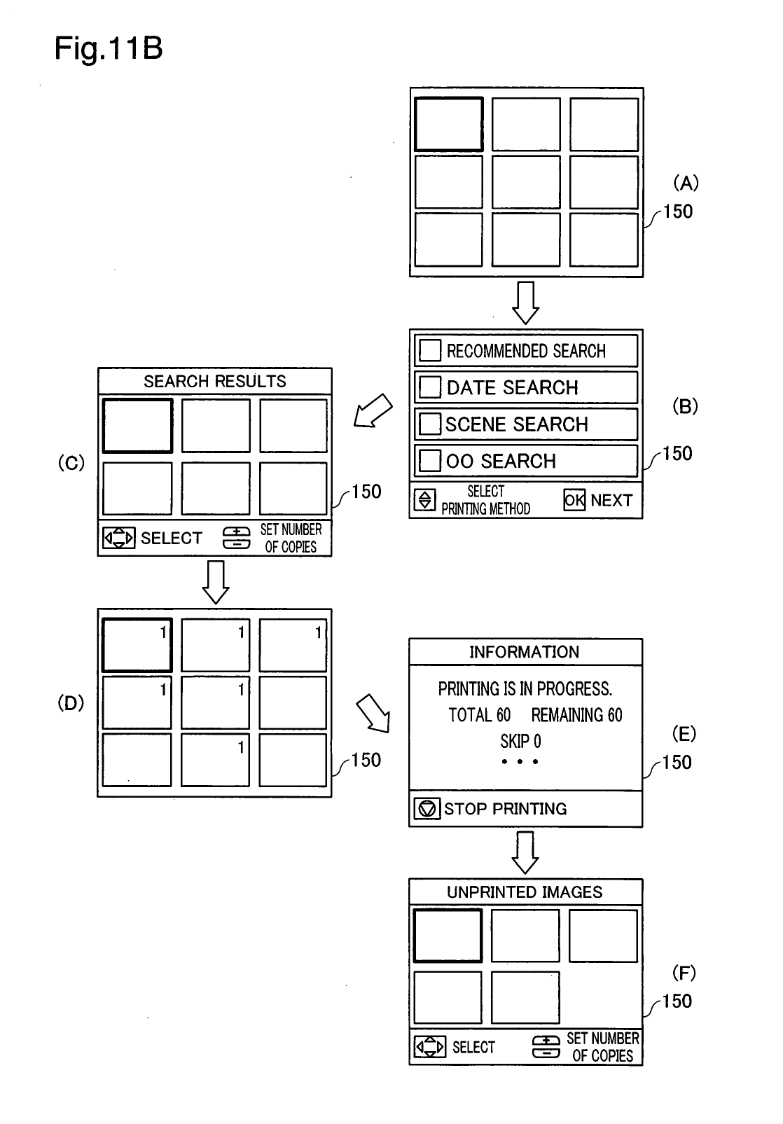

For example, as shown in FIG. 11B, in a state with the images in the memory card MC displayed (here, it is possible to display 9 images together), when the display switch button 143 shown in FIG. 11A is pressed, the image search menu is displayed (see code (B) in this drawing). On this menu screen are displayed as choices items for which images are searched for from within the memory card MC. From among these, when the “Recommended search” mode is selected, the recommended images focused based on the evaluation of the exposure, hand held blur, blurred focus, composition and the like are displayed as the search results (code (C) in the drawing). Here, when the user confirms the displayed recommended images, selects the printing subjects using a specified operation, specifies the number to be printed (code (D) in the drawing), and performs print execution instructions, information to the effect that printing is in progress is displayed (code (E) in the drawing), and printing is performed. Then, after printing ends, unprinted images are displayed on the liquid crystal display 150 (code (F) in the drawing). With this kind of printing process, together with being able to confirm and print recommended images, it is also possible to confirm unprinted images, and to improve the convenience for the user.

With this embodiment, printing flags were temporarily stored in the memory 253 of the printing device 100, but for example, it is also possible to do non-volatile writing of printing flags to the EEPROM 254. By working in this way, at a later date, even when the memory card MC is mounted in the printing device 100, it is possible to confirm unprinted images. Also, there are many cases when unprinted images are images not needed by the user. Information of this kind of unnecessary image can be stored, and can be used for deleting images from the memory card MC, and the like.

The recommended image determination unit of the printing device that the constitution noted above has is a unit that performs a process of determining whether or not that image is a recommended image each time the one image data noted above is input, but it is also possible to have it be a unit that performs this determination process when unprocessed image data is input during the process wait time for printing of one image set as the printing subject when it is determined to be a recommended image. By working in this way, it is possible to quickly perform the printing process, and it is possible to shorten the overall processing time for printing.

Following, another constitution example of the present invention is described. With the printing device of the present invention, the printing unit can also be an item which further sets as printing subjects images selected from among the unprinted images aligned in a specified sequence on the display unit, and that performs printing of those images.

According to this printing device, it is possible to print desired images from among the displayed unprinted images. Therefore, it is possible to print the necessary images without waste, and it is possible to improve the convenience for the user.

The specified sequence in which the unprinted images are aligned with the printing device that the constitution noted above has can be the time series sequence based on the date and time the image was shot, or a sequence based on the size of the evaluation values of that image. By working in this way, confirmation of the unprinted images is easy. In particular when aligned in the high evaluation value sequence, it is possible to quickly confirm high evaluation images. When aligned in low evaluation value sequence, it is easy to confirm images which do not need to be printed.

The specified items evaluated by the recommended image determination unit of the printing device that the constitution noted above has can be any of at least the level of image hand held blur, the image blurred focus, or the under or over exposure state of the image.

According to this printing device, evaluation is performed for the typical items as the photographic image evaluation. Therefore, it is possible to suitably determine the recommended images that are potential printing subjects.

The recommended image determination unit of the printing device that the constitution noted above has can also be a unit that, when the similarity level between the input image data is evaluated, groups the plurality of image data based on that evaluation, and when there are a plurality of similar images suitable as printing subjects within that group, selects one image from that plurality of similar images based on specified criteria, and determines that image to be a recommended image.

According to this printing device, similar images are grouped, and only one image from within the group is set as the recommended image. Therefore, there will not be printing of a large number of similar images.

The image display unit of the printing device that the constitution noted above has can also be a unit for which for images that were not determined to be recommended images and were not printed, the reason for not printing is displayed together with that unprinted image.

According to this printing device, the reason for not printing is displayed together with the unprinted image. Therefore, it is easy to understand the image contents.

The image display unit of the printing device that the constitution noted above has can also be an item for which there is an operating button for switching the image display of the display unit, and according to the number of times that operating button is pressed, images are displayed by switching in sequence the first display aspect of displaying unprinted images, the second display aspect of displaying printed images, and the third display aspect of displaying all screens. With this kind of various display aspect, it is possible to make it easy to do image confirmation work.

The image display unit of the printing device that the constitution noted above has can also be a unit that has an operating button for switching the image display of the display unit, and according to pressing of that operating button in a state with unprinted images selected for the reason that they were similar images displayed in the display unit, printed images belonging to the same group as those similar images are displayed on that display unit. By working in this way, it is possible to easily confirm printed images in the same group based on the images that were not printed because they were similar images. As a result, it is possible to improve the convenience for the user.

The present invention is not limited to the embodiments noted above, and of course it is possible to implement various aspects within a scope that does not change the gist of the key points. The protected scope of the present invention is established only by the notation of the claims below and the spirit of the present invention.

What is claimed is:

1. A printing device for printing images comprising:
a display unit that displays images;
an input unit that inputs a plurality of image data,
a recommended image determination unit that for each of said input image data, calculates an evaluation value by evaluating specified items in relation to the level of deviation from the images shot under pre-specified conditions as the photographic images, and based on this evaluation value, determines whether or not each of said photographic images is a recommended image;
a printing unit that selects images as a printing subject based on said judgment results and prints the selected images;
an identifier storage unit that correlates an identifier to each of images selected as the printing subject and stores the identifier; and
an image display unit that, after said image selected as the printing subject is printed, inquires for the stored identifier to judge the images not to be printed, and displays the judged images aligned in a specified sequence on said display unit.

2. A printing device in accordance with claim 1, wherein
said recommended image determination unit, when said photographic image is determined to be suitable as a printing subject, sets the image as a recommended image.

3. A printing device in accordance with claim 1, wherein
said recommended image determination unit performs the process of determining whether or not that image is a recommended image each time a specified number of said image data is input.

4. A printing device in accordance with claim 1, wherein
said recommended image determination unit inputs unprocessed image data and performs said determining process during a processing wait time of printing for printing one image selected as a printing subject among the recommended images.

5. A printing device in accordance with claim 1, the device further comprising:
an image selection unit that selects a specified image as the printing subject from among the unprinted images displayed on said display unit by said image display unit.

6. A printing device in accordance with claim 1, wherein
said specified sequence used in said image display unit is either the time series sequence based on the date and time said image was shot, or the size sequence of said evaluation values from evaluating said images.

7. A printing device in accordance with claim 1, wherein
the specified items evaluated by said recommended image determination unit include at least one of the level of hand held blur of the image, the blurred focus of the image, or the over or under exposure state of the image.

8. A printing device in accordance with claim 1, wherein
said recommended image determination unit comprises a unit that evaluates the level of similarity between said input image data, and groups as similar images the images corresponding to said plurality of image data based on said evaluation of the level of similarity; and
said recommended image determination unit selects one image from said plurality of similar images based on specified criteria, when within said group is contained a plurality of images determined to be recommended images, and determines that the selected image is a recommended image.

9. A printing device in accordance with claim 1, wherein
said image display unit displays on said display unit the image of unprinted images with the determined contents and a correlated information for the unprinted images out of recommendation.

10. A printing device in accordance with claim 1, wherein
said image display unit has an operating button for switching the image display of said display unit that according to an operating state of said operating button switches in sequence at least two display aspects of a first display aspect that displays unprinted images, a second display aspect that displays printed images, and a third display aspect that displays all images, and displays the images.

11. A printing device in accordance with claim 8, wherein
said image display unit has an operating button that switches the image display of said display unit and displays on said display unit printed images belonging to the same group as said similar images, according to an operation of said operating button in a state with images selected that were not printed because of existence of said similar images and displayed in said display unit.

12. A method of printing images comprising:
inputting a plurality of image data;
for each of said input image data, calculating an evaluation value by evaluating specified items in relation to the level of deviation from the images shot under pre-specified conditions as the photographic images, and based on this evaluation value, determining whether or not each of said photographic images is a recommended image;
selecting images as a printing subject based on said determination results and printing the selected images;
correlating an identifier to each of images selected as the printing subject and storing the identifier; and
after said image selected as the printing subject is printed, inquiring for the stored identifier to judge the images not to be printed, and displaying the judged images aligned in a specified sequence on said display unit.
